(19) United States
(12) Patent Application Publication
(10) Pub. No.: US 2005/0035998 A1
(43) Pub. Date: Feb. 17, 2005

(54) Ink jet print head, inkjet printer including the inkjet print head, and method of manufacturing inkjet print head

(76) Inventors: Makoto Ando, Tokyo (JP); Hiroshi Tokunaga, Tokyo (JP); Atsushi Nakamura, Kanagawa (JP); Shinji Kayaba, Tokyo (JP); Shinichi Horii, Kanagawa (JP)

Correspondence Address: ROBERT J. DEPKE LEWIS T. STEADMAN;HOLLAND & KNIGHT LLC, 131 SOUTH DEARBORN, 30TH FLOOR, CHICAGO, IL, 60603, US

(21) Appl. No.: 10/494,502

(22) PCT Filed: Nov. 1, 2002
(86) PCT No.: PCT/JP02/11445

(30) Foreign Application Priority Data
May 11, 2001 (JP) 2001-339780

(51) Int. Cl. B41J 2/14

(52) U.S. Cl. 347/47; 347/43

(57) ABSTRACT

An inkjet print head includes one nozzle sheet (23) and a plurality of head chips (25) including a plurality of heaters. The nozzle sheet (23) is formed of an electroformed metal layer made of nickel or a material comprising nickel, and has discharge nozzle rows for respective colors disposed so that the discharge nozzles are in staggered arrangements and so that each set of discharge nozzles partly overlaps another set of discharge nozzles in a sheet-feed direction. The head chips are positioned at and affixed to a growth surface side of the nozzle sheet (23) in staggered arrangements so that the positions of the discharge nozzles and the positions of the heaters correspond to each other. Accordingly, reduction in printing quality caused by displacement of any of the discharge nozzles is prevented from occurring, and landing positions of discharged ink on a recording sheet are stabilized.

### TECHNICAL FIELD

The present invention relates to an inkjet print head capable of full color printing and having a plurality of recording elements disposed in a print width direction, an inkjet printer including the inkjet print head, and a method for producing the inkjet print head.

### BACKGROUND ART

In recent years, a demand for higher printing speed is drawing attention to an inkjet printer performing line printing (hereinafter may simply be referred to as “line printer”). The line printer can print a predetermined image in color without moving a print head having discharge nozzles by selectively causing ink drops to fly from the discharge nozzles onto a recording sheet while transporting the recording sheet. Rows of the discharge nozzles provided over a print width of the recording sheet are successively disposed for respective colors in a direction substantially perpendicular to a recording sheet transportation direction.

Of inkjet printers as that described above, for example, a line printer including a print head having a plurality of head chips disposed side by side is disclosed as a thermal printer in Japanese Unexamined Patent Application Publication No. 2001-71495. In the thermal printer, heating resistors are used as energy generating elements for generating pressure energy for discharging ink from discharge nozzles.

The head chips cause ink drops to fly from the discharge nozzles by heating ink in ink chambers by heaters, that is, the heating resistors. The heaters, etc., are provided on one semiconductor substrate in correspondence with the number of discharge nozzles.

The entire structure of the above-described printer can be simplified by constructing a line print head by disposing a plurality of the head chips side by side in correspondence with color inks.

In addition, the above-described printer can print at a higher speed than an inkjet printer of a type in which a print head performs scanning because its print head does not need to perform scanning in a print width direction. Further, the above-described printer has an advantage in that its first print time is shorter than that of an electrophotographic laser beam printer capable of performing color printing because it does not require a fixing device.

However, it is difficult to put such a related line printer described above into practical use because it has the following problems.

In the related example, the discharge nozzles are positioned in correspondence with the positions of the head chips. Therefore, in a print head for discharging ink of a particular color, if an error occurs in the positioning of any of the head chips, the nozzles for discharging the ink of the particular color are displaced. As a result, the color ink does not land on the proper position, thereby reducing printing quality. Such a problem occurs due to the use of a structure comprising nozzles disposed in correspondence with the positions of the head chips.

This problem will be described with reference to FIGS. 13A to 13D.

FIG. 13A shows a case in which, for example, when a print head is formed by disposing head chips 30A to 30D for respective color inks so that one head chip is in advance of or behind a corresponding head chip (staggered arrangement), discharge nozzles are disposed at equal intervals in an arrangement direction of the head chips 30A to 30D, that is, the head chips are not displaced. FIGS. 13B to 13D each show a case in which there is an error in the positioning of any of the head chips.

FIG. 13B shows the case in which the head chip 30C is displaced in the arrangement direction. In this case, changes occur in the nozzle pitch at a boundary between the displaced head chip 30C and the adjacent head chip 30B and at a boundary between the displaced head chip 30C and the adjacent head chip 30D. Therefore, uneven printing with streaks occurs in a sheet transportation direction.

FIG. 13C shows the case in which the head chip 30B is displaced in the sheet transportation direction. In this case, the discharge nozzles at the head chip 30B are displaced in the sheet transportation direction by an amount corresponding to the displacement of the head chip 30B. Therefore, when, for example, printing of a horizontal straight line is carried out, a portion of an image is displaced at a print area of the head chip 30B. Consequently, a stepped portion is formed in the printed straight line.

FIG. 13D shows the case in which the head chip 30D is tilted. In this case, the discharge nozzles at the head chip 30D are also tilted. Therefore, when, for example, printing of a horizontal straight line is carried out, the printed straight line is bent. In addition, since the interval between the head chip 30C and the head chip 30D is increased, a white streak is produced when printing of a solid black image is carried out.

As described above, the discharge nozzles are positioned in correspondence with the positions of the head chips. Accordingly, when a color print head is constructed by disposing head chip rows in correspondence with yellow, magenta, cyan, and black inks, the following problem occurs even if the precision with which the head chip corresponding to one color is positioned is increased as stated in, for example, Japanese Examined Patent Application Publication No. 7-115504. That is, a positioning error in any of the head chip rows for the respective colors causes what is called registration to occur between the ink discharge nozzles for one color and those for another color. This leads to a reduction in color reproducibility, resulting in a reduction in printing quality as described above.

This problem will be described with reference to FIGS. 14A to 14C. In FIGS. 14A to 14C, it is assumed that the head chips for respective single colors are precisely positioned.

FIG. 14A shows a case in which a head chip row 32 corresponding to a particular color is displaced in a print width direction when head chip rows for the respective colors, yellow (Y), magenta (M), cyan (C), and black (K), are disposed in that order in a recording sheet transportation direction. In this case, a magenta (M) image formed by the displaced head chip row 32 for magenta (M) is printed by being displaced in a horizontal direction (arrangement direction of each head chip) from other images formed by inks of the other colors.

FIG. 14B shows a case in which a head chip 32 corresponding to another particular color (that is, the head chip row 32 corresponding to yellow (Y)) is displaced in a recording sheet transportation direction. In this case, a yellow image formed by the displaced head chip row 32 for yellow is printed by being displaced in the sheet transportation direction from other images formed by inks of the other colors.

FIG. 14C shows a case in which head chip rows 32 corresponding to particular colors (that is, magenta (M), cyan (C), and black (K) head chip rows 32) are tilted. In this case, images formed by inks of the particular colors by the tilted head chip rows 32 are printed on the recording sheet at smaller dot intervals. Therefore, the images are twisted with respect to an image formed by ink of the remaining color, that is, the images are printed in a tilted state.

As described above, the positions of the ink discharge nozzles considerably affect the printing quality, so that high precision is required. This is particularly important for a printer capable of printing using a plurality of colors.

The shapes of the ink discharge nozzles also considerably affect the printing quality, so that high precision is required. In order to stabilize ink discharge angles, that is, to increase ink landing precision, the cross-sectional shapes of the discharge nozzles are smoothly narrower from the inner side (head chip 25 side) to the outer side (discharge surface side) of a print head in correspondence with discharge nozzles 31 shown in FIG. 4. This is because, if the cross-sectional shapes are wider from the inner side to the outer side of the print head, scattered ink is discharged, thereby reducing the landing precision of the ink on the recording sheet.

### DISCLOSURE OF INVENTION

In view of the above-described problems, it is an object of the present invention to provide an inkjet print head capable of preventing a reduction in printing quality due to displacement of a discharge nozzle, and stabilizing a landing position of discharged ink on a recording sheet, an inkjet print head including the inkjet print head, and a method for producing the inkjet print head.

To overcome the aforementioned problems, there is provided an inkjet print head having a plurality of recording elements disposed in a print width direction for discharging ink from discharge nozzles. The inkjet print head comprises one nozzle sheet comprising a predetermined electroformed metal layer and having the discharge nozzles disposed in rows for respective ink colors.

To overcome the aforementioned problems, there is provided an inkjet print head having a plurality of recording elements disposed in a print width direction for discharging ink from discharge nozzles. The inkjet print head comprises one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to the nozzle sheet so that the discharge nozzles in predetermined numbers in the discharge nozzle rows for the respective colors correspond to the recording elements.

To overcome the aforementioned problems, there is provided an inkjet print head having a plurality of recording elements disposed in a print width direction for discharging ink from discharge nozzles. The inkjet print head comprises one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to a growth surface of the nozzle sheet so that the discharge nozzles in predetermined numbers in the discharge nozzle rows for the respective colors correspond to the recording elements.

To overcome the aforementioned problems, there is provided an inkjet print head having a plurality of recording elements disposed in a print width direction for discharging ink from discharge nozzles. The inkjet print head comprises one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to the nozzle sheet so that the discharge nozzles in predetermined numbers in the discharge nozzle rows for the respective colors correspond to the recording elements. Each discharge nozzle row for the corresponding color is disposed in a substantially straight line in the print width direction, and the substrate members are disposed in rows in straight lines in correspondence with the discharge nozzles.

To overcome the aforementioned problems, there is provided an inkjet print head having a plurality of recording elements disposed in a print width direction for discharging ink from discharge nozzles. The inkjet print head comprises one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to a growth surface of the nozzle sheet so that the discharge nozzles in predetermined numbers in the discharge nozzle rows for the respective colors correspond to the recording elements. Each discharge nozzle row for the corresponding color is disposed in a substantially straight line, and the substrate members are disposed in rows in straight lines in correspondence with the discharge nozzles.

To overcome the aforementioned problems, there is provided an inkjet print head having a plurality of recording elements disposed in a print width direction for discharging ink from discharge nozzles. The inkjet print head comprises one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to the nozzle sheet so that the discharge nozzles in predetermined numbers in the discharge nozzle rows for the respective colors correspond to the recording elements. The discharge nozzle rows for the respective colors are disposed so that the discharge nozzles in predetermined numbers are in staggered arrangements, and the substrate members are in staggered arrangements in correspondence with the discharge nozzles.

To overcome the aforementioned problems, there is provided an inkjet print head having a plurality of recording elements disposed in a print width direction for discharging ink from discharge nozzles. The inkjet print head comprises one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to a growth surface of the nozzle sheet so that the discharge nozzles in predetermined numbers in the discharge nozzle rows for the respective colors correspond to the recording elements. The discharge nozzle rows for the respective colors are disposed so that the discharge nozzles in predetermined numbers are in staggered arrangements, and the substrate members are in staggered arrangements in correspondence with the discharge nozzles.

To overcome the aforementioned problems, there is provided an inkjet print head having a plurality of recording elements disposed in a print width direction for discharging ink from discharge nozzles. The inkjet print head comprises one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to the nozzle sheet so that the discharge nozzles in predetermined numbers in the discharge nozzle rows for the respective colors correspond to the recording elements. The discharge nozzle rows for the respective colors are disposed so that the discharge nozzles in predetermined numbers are in staggered arrangements and so that each set of the discharge nozzles partly overlaps another set of the discharge nozzles in a recording medium transportation direction, and the substrate members are in staggered arrangements in correspondence with the discharge nozzles.

To overcome the aforementioned problems, there is provided an inkjet print head having a plurality of recording elements disposed in a print width direction for discharging ink from discharge nozzles. The inkjet print head comprises one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to a growth surface of the nozzle sheet so that the discharge nozzles in predetermined numbers in the discharge nozzle rows for the respective colors correspond to the recording elements. The discharge nozzle rows for the respective colors are disposed so that the discharge nozzles in predetermined numbers are in staggered arrangements and so that each set of the discharge nozzles partly overlaps another set of the discharge nozzles in a recording medium transportation direction, and the substrate members are in staggered arrangements in correspondence with the discharge nozzles.

To overcome the aforementioned problems, there is provided an inkjet printer comprising a replaceable head cartridge comprising an inkjet print head having a plurality of recording elements disposed in a print width direction for discharging ink from discharge nozzles, and one nozzle sheet comprising a predetermined electroformed metal layer and having the discharge nozzles disposed in rows for respective ink colors.

To overcome the aforementioned problems, there is provided an inkjet printer comprising a replaceable head cartridge comprising an inkjet print head having a plurality of recording elements disposed in a print width direction for discharging ink from discharge nozzles; one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to the nozzle sheet so that the discharge nozzles in predetermined numbers in the discharge nozzle rows for the respective colors correspond to the recording elements.

To overcome the aforementioned problems, there is provided an inkjet printer comprising a replaceable head cartridge comprising an inkjet print head having a plurality of recording elements disposed in a print width direction for discharging ink from discharge nozzles; one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to a growth surface of the nozzle sheet so that the discharge nozzles in predetermined numbers in the discharge nozzle rows for the respective colors correspond to the recording elements.

To overcome the aforementioned problems, there is provided an inkjet printer comprising a replaceable head cartridge comprising an inkjet print head having a plurality of recording elements disposed in a print width direction for discharging ink from discharge nozzles; one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to the nozzle sheet so that the discharge nozzles in predetermined numbers in the discharge nozzle rows for the respective colors correspond to the recording elements. Each discharge nozzle row for the corresponding color is disposed in a substantially straight line, and the substrate members are disposed in rows in straight lines in correspondence with the discharge nozzles.

To overcome the aforementioned problems, there is provided an inkjet printer comprising a replaceable head cartridge comprising an inkjet print head having a plurality of recording elements disposed in a print width direction for discharging ink from discharge nozzles; one nozzle sheet comprising a predetermined electroformed metal layer and having the discharge nozzles disposed in rows for respective ink colors; and a plurality of substrate members, each including at least two of the plurality of recording elements. the substrate members are positioned at and affixed to a growth surface of the nozzle sheet of the nozzle sheet so that the discharge nozzles in predetermined numbers in the discharge nozzle rows for the respective colors correspond to the recording elements. Each discharge nozzle row for the corresponding color is disposed in a substantially straight line, and the substrate members are disposed in rows in straight lines in correspondence with the discharge nozzles.

To overcome the aforementioned problems, there is provided an inkjet printer comprising a replaceable head cartridge comprising an inkjet print head having a plurality of recording elements disposed in a print width direction for discharging ink from discharge nozzles; one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to the nozzle sheet so that the discharge nozzles in predetermined numbers in the discharge nozzle rows for the respective colors correspond to the recording elements. The discharge nozzle rows for the respective colors are disposed so that the discharge nozzles in predetermined numbers are in staggered arrangements with respect to a recording medium transportation direction, and the substrate members are in staggered arrangements in correspondence with the discharge nozzles.

To overcome the aforementioned problems, there is provided an inkjet printer comprising a replaceable head cartridge comprising an inkjet print head having a plurality of recording elements disposed in a print width direction for discharging ink from discharge nozzles; one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to a growth surface of the nozzle sheet so that the discharge nozzles in predetermined numbers in the discharge nozzle rows for the respective colors correspond to the recording elements. The discharge nozzle rows for the respective colors are disposed so that the discharge nozzles in predetermined numbers are in staggered arrangements with respect to a recording medium transportation direction, and the substrate members are in staggered arrangements in correspondence with the discharge nozzles.

To overcome the aforementioned problems, there is provided an inkjet printer comprising a replaceable head cartridge comprising an inkjet print head having a plurality of recording elements disposed in a print width direction for discharging ink from discharge nozzles; one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to the nozzle sheet so that the discharge nozzles in predetermined numbers in the discharge nozzle rows for the respective colors correspond to the recording elements. The discharge nozzle rows for the respective colors are disposed so that the discharge nozzles in predetermined numbers are in staggered arrangements and so that each set of the discharge nozzles partly overlaps another set of the discharge nozzles in a recording medium transportation direction, and the substrate members are in staggered arrangements in correspondence with the discharge nozzles.

To overcome the aforementioned problems, there is provided an inkjet printer comprising a replaceable head cartridge comprising an inkjet print head having a plurality of recording elements disposed in a print width direction for discharging ink from discharge nozzles; one nozzle sheet comprising a predetermined electroformed metal layer and having the discharge nozzles disposed in rows for respective ink colors; and a plurality of substrate members, each including at least two of the plurality of recording elements. The substrate members are positioned at and affixed to a growth surface of the nozzle sheet so that the discharge nozzles in predetermined numbers in the discharge nozzle rows for the respective colors correspond to the recording elements. The discharge nozzle rows for the respective colors are disposed so that the discharge nozzles in predetermined numbers are in staggered arrangements and so that each set of the discharge nozzles partly overlaps another set of the discharge nozzles in a recording medium transportation direction, and the substrate members are in staggered arrangements in correspondence with the discharge nozzles.

To overcome the aforementioned problems, there is provided a method for producing an inkjet print head having a plurality of recording elements disposed in a print width direction for discharging ink from discharge nozzles, the method comprising the steps of forming a resist layer having a predetermined pattern onto an electrically conductive substrate using an insulating photoresist material in correspondence with sizes of and distances between the discharge nozzles disposed in rows for respective ink colors; selectively forming a layer on a portion of the substrate where the resist layer is not formed by electroforming using a predetermined metal; removing the resist layer; separating the electroformed layer from the substrate; and positioning a substrate member comprising the plurality of recording elements at and affixing the substrate member to a nozzle sheet so that the discharge nozzles in predetermined numbers in the discharge nozzle rows for the respective colors correspond to the recording elements, the nozzle sheet being formed by separating the electroformed layer from the substrate.

### BRIEF DESCRIPTION OF THE DRAWINGS

FIG. 1 is an exploded perspective view of a detailed structure of a head of a first embodiment.

FIG. 2 illustrates the steps of forming a nozzle sheet in the embodiment.

FIG. 3 is a sectional view of a detailed structure of the head of the embodiment.

FIG. 4 is a sectional view showing the relationship between the positions of head chips and the position of the nozzle sheet.

FIG. 5 is a plan view of the arrangement of the head chips in the first embodiment.

FIGS. 6A to 6G illustrate the order in which heaters are driven in the embodiment.

FIG. 7 is an exploded perspective view of a detailed structure of a head of a second embodiment.

FIG. 8 is a plan view of the arrangement of head chips in the second embodiment.

FIG. 9 is a plan view of the arrangement of head chips in a third embodiment.

FIGS. 10A to 10D illustrate the positions of head chip rows for respective colors when any of the head chip rows for respective colors are displaced in a print head of the third embodiment.

FIGS. 11A to 11C illustrate the positions of the head chips when any of the head chips for particular colors are displaced in the print head of the first embodiment.

FIG. 12 is a perspective view of an internal structure of a line printer of an embodiment.

FIGS. 13A to 13D illustrate the positions of head chips when any head chips for particular colors are displaced in a related print head.

FIGS. 14A to 14C illustrate the positions of head chip rows for respective colors when any of the head chip rows for respective colors are displaced in a related color print head.

### BEST MODE FOR CARRYING OUT THE INVENTION

Hereunder, embodiments of the present invention will be described with reference to the drawings.

(First Embodiment)

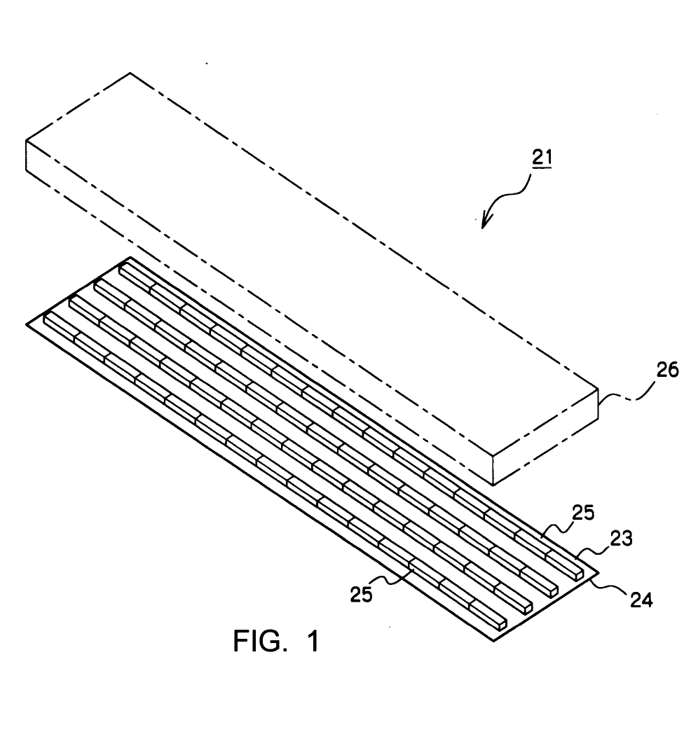

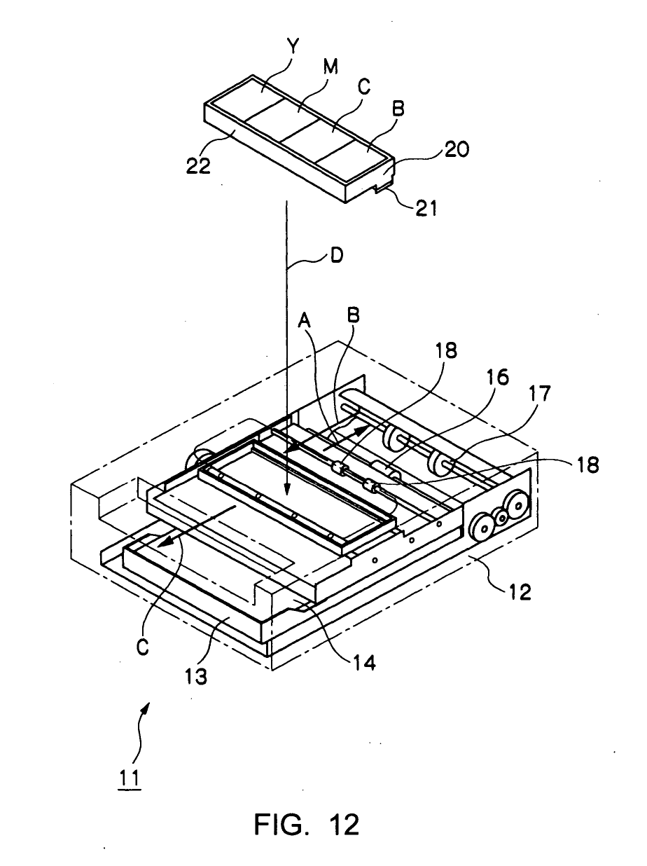

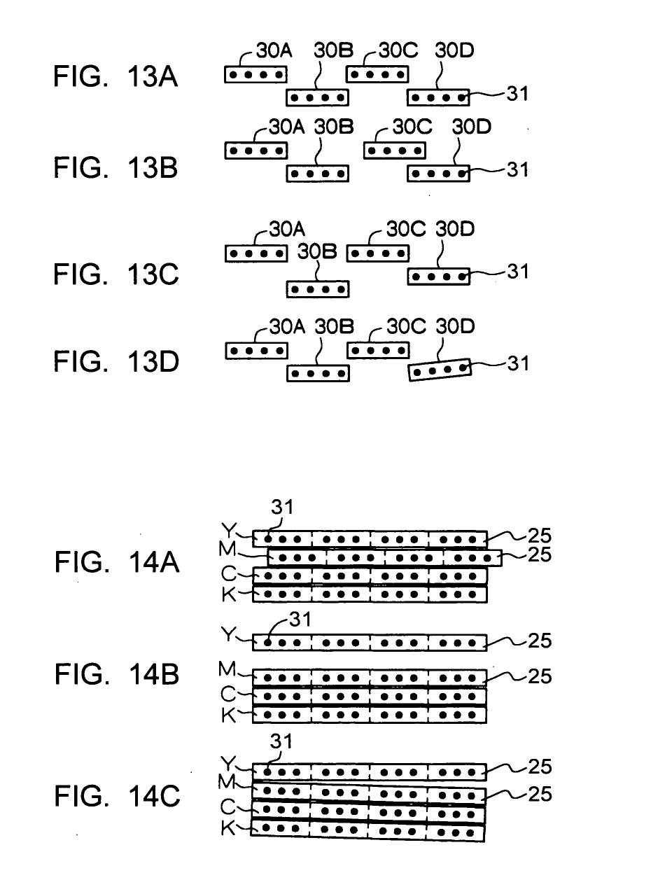

As shown in FIG. 1, an inkjet print head (hereinafter simply referred to as “head”) 21 which performs line printing and has a plurality of recording elements disposed in a print width direction for discharging ink from discharge nozzles is formed of an electroformed layer formed of nickel or a material comprising nickel. The head 21 comprises a nozzle sheet 23, a plurality of head chips (substrate members) 25, and a member 26. In the nozzle sheet 23, four discharge nozzle rows for respective colors, yellow, magenta, cyan, and black, are disposed in correspondence with printing operations using the colors yellow, magenta, cyan, and black and in substantially straight lines in a direction in which the rows traverse a sheet (that is, print width direction). In correspondence with the discharge nozzle rows for the respective colors, the head chips 25 are successively disposed on the nozzle sheet 23 in straight lines and are affixed to the nozzle sheet 23. A surface of the member 26 facing the head chips 25 is subsequently processed into a rough surface, and is affixed to the nozzle sheet 23, so that ink paths are formed between the member 26 and a head cartridge 20 shown in FIG. 12.

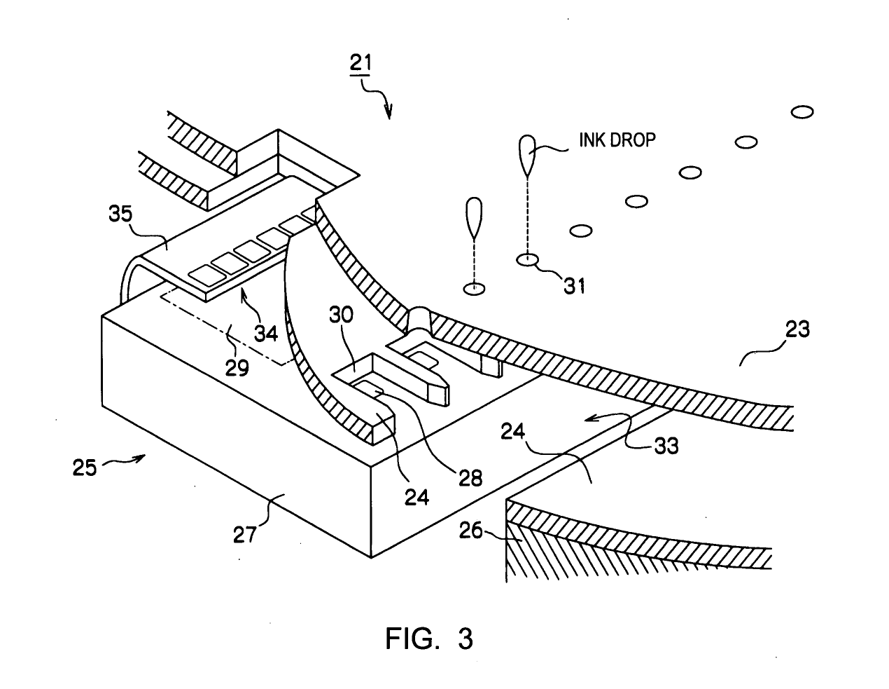

As shown in FIG. 3, the head chips 25 are formed by processing a silicon substrate 27 by integrated circuit techniques. Each head chip 25 comprises heaters 28 and a drive circuit 29. The heaters 28 are heating elements (recording elements) for heating ink and are successively disposed side by side. The drive circuits 29 drive the heaters 28.

The nozzle sheet 23 is processed so that circular cross section openings are disposed above the respective heaters 28. For example, partitions for the heaters 28 are formed by dry films 24, so that ink chambers 30 are formed at the respective heaters 28. Discharge nozzles 31 are formed in the nozzle sheet 23 so that ink drops 36 can fly.

Such heaters 28 are disposed near sides of the respective head chips 25. A side of each drive film 24 where the heaters 28 are formed has the shape of comb teeth so as to expose the ink chambers 30. In the head 21, ink paths 33 are defined by the member 26 and the dry films 24 so that ink contained in ink cartridges Y, M, C, and B shown in FIG. 12 is guided from the exposed sides. Therefore, in the head 21, the ink is guided to the ink chambers 30 at the respective heaters 28 from longitudinal edges of the head chips 25.

In each head chip 25, a pad 34 is formed at a side opposite to the side where the heaters 28 are provided. Flexible wiring substrates 35 are connected to the pads 34 so that the head chips 25 can be driven. Accordingly, in the head 21, an ink discharge mechanism for causing the ink drops 36 to fly from the discharge nozzles 31 comprises the heaters 28, the ink chambers 30, and the discharge nozzles 31. The head chips 25 are formed by successively disposing the heaters 28 of the ink discharge mechanism side by side.

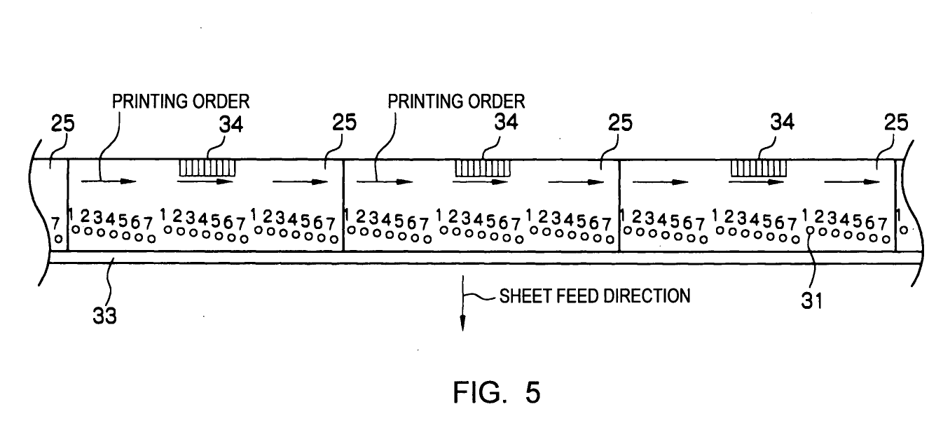

FIG. 5 shows the arrangement of the head chips 25 in the embodiment, and is an enlarged view of a portion from a side of a sheet 14 in FIG. 12. As shown in FIG. 5, the head chips 25 having the same structures are disposed in a straight line on the nozzle sheet 23, at one side of the ink paths 33 for the respective colors.

In the head 21, the nozzle sheet 23 is formed so that predetermined numbers of successively formed discharge nozzles 31 are grouped in units, and so that the positions of the discharge nozzles 31 in each group are shifted in a sheet feed direction. In correspondence with the nozzle sheet 23, predetermined numbers of heaters 28 of each head chip 25 are grouped in units, and their positions are shifted in the sheet feed direction. FIG. 5 exaggerates the shift amounts in the sheet feed direction. In order to, for example, simplify the description, FIG. 5 shows a case in which three groups of seven discharge nozzles are used.

This allows each head chip 25 to effectively use the discharge nozzles whose positions are shifted in the sheet feed direction in order to successively drive the grouped heaters.

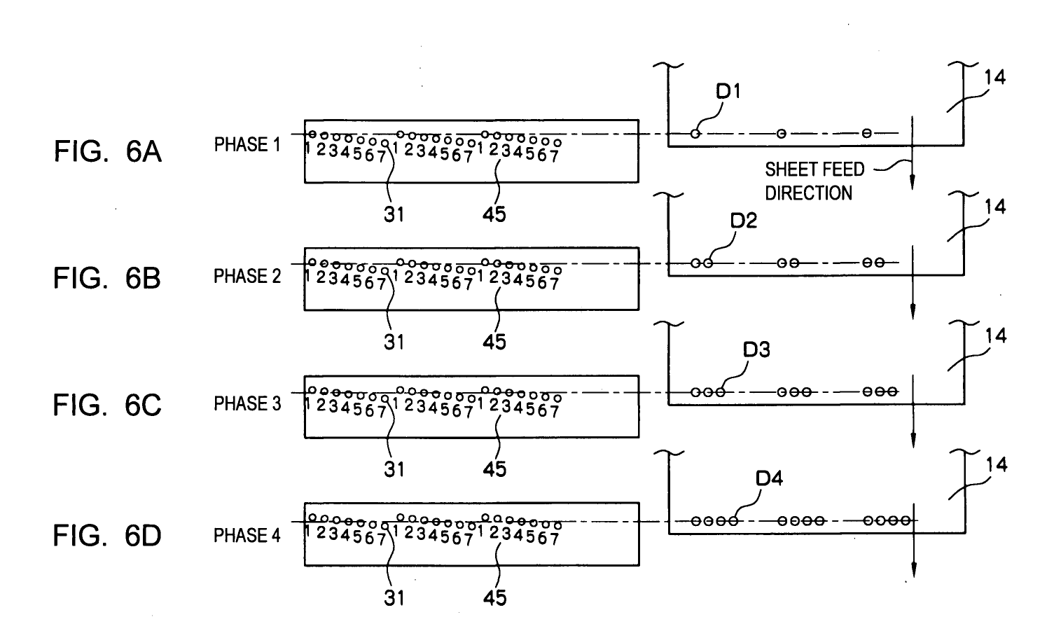

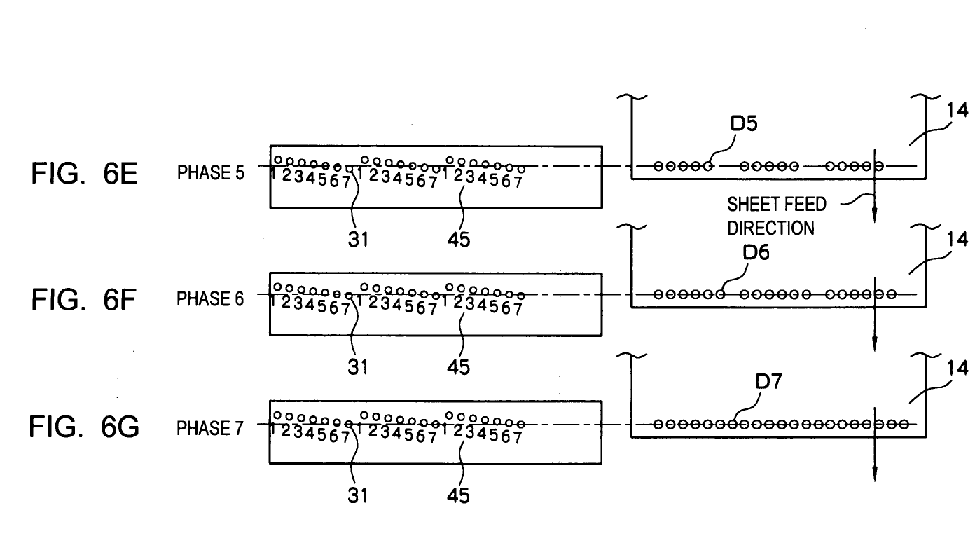

The order in which the heaters 28 are drive will be described with reference to FIGS. 6A to 6G. Seven discharge nozzles 31 of each group are successively controlled in stages from phases 1 to 7 from the discharge nozzles 31 at a sheet 14 entering side. In FIGS. 6A and 6G, the discharge nozzles are given numbers in correspondence with the respective phase numbers.

As shown in FIG. 6A, when the sheet 14 shown in FIG. 12 is fed, in phase 1, discharge nozzles 1 nearest the sheet entering side are driven in order to form dots D1. Then, when the sheet 14 is fed to the positions of next discharge nozzles 2 (FIG. 6B), the next discharge nozzles 2 are driven to form dots D2. Subsequently, discharge nozzles 3 to 7 are successively driven in synchronism with the sheet feed to successively form respective dots (FIGS. 6C to 6G). Accordingly, in the embodiment, the discharge nozzles 31 in one group are driven at different timings, and the discharge nozzles 31 labeled with the same numbers in different groups can be driven at the same time.

In the head 21, a liquid drop for forming one dot is used to form one dot. By varying the number of liquid drops for forming this one dot, the size of the dot is varied, so that a tone is produced. In the embodiment, up to eight liquid drops are used to form one dot.

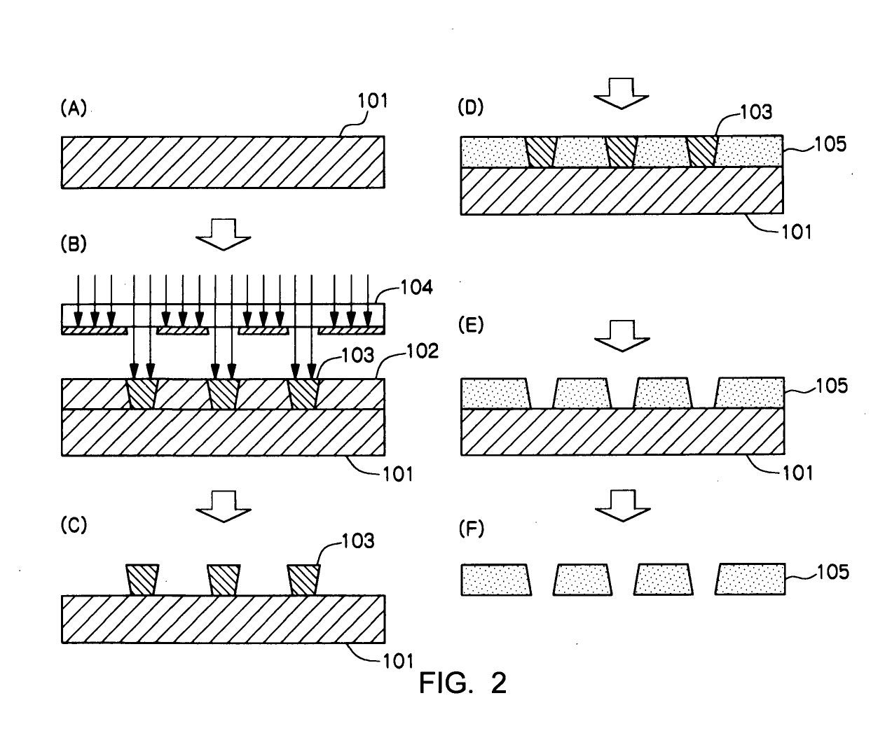

A method for forming the above-described nozzle sheet 23 will be described with reference to FIG. 2. In order to simplify the description, in FIG. 2, only some of the discharge nozzles are shown.

First, as shown in FIG. 2(B), an insulating photoresist material is used to form a resist layer 102 with a thickness of approximately 14 to 15 μm onto a stainless-steel substrate (matrix) 101 shown in FIG. 2(A). The substrate 101 is electrically conductive and has a thickness of approximately 1 mm. Using a mask 104, only a pattern resist layer 103 is irradiated with laser light. The pattern resist layer 103 is formed for disposing discharge nozzles in rows for respective colors substantially in straight lines and in the print width direction as shown in FIG. 5. The size of each discharge nozzle in each discharge nozzle row of the corresponding color is approximately 17 μm, and the interval between the centers of adjacent nozzles is approximately 42 μm.

Next, as shown in FIG. 2(C), development is carried out, after which, as shown in FIG. 2(D), an electroformed layer 105 is selectively formed to a thickness of approximately 12 μm on portions of the substrate (matrix) 101 where the resist layer 103 is not formed (the substrate 101 is plated). The electroformed layer 105 is formed of nickel or a material comprising nickel. Then, as shown in FIG. 2(E), the resist layer 103 is removed. After this, the electroformed layer 105 is separated from the substrate 101, thereby forming the nozzle sheet 23.

The above-described nozzle sheet having the discharge nozzle rows for the respective colors may also be formed by etching or punching. However, the etching method, which is a wet etching method, is an isotropic etching method, and, thus, makes it difficult to form the discharge nozzles with the proper sizes with high precision.

The punching method has poor reproducibility because it is difficult to continue forming holes corresponding to the discharge nozzles with the same shape and size when a punching blade is replaced. In addition, the punching method results in high manufacturing costs because in requires a secondary processing operation due to burrs that remain when the holes are formed.

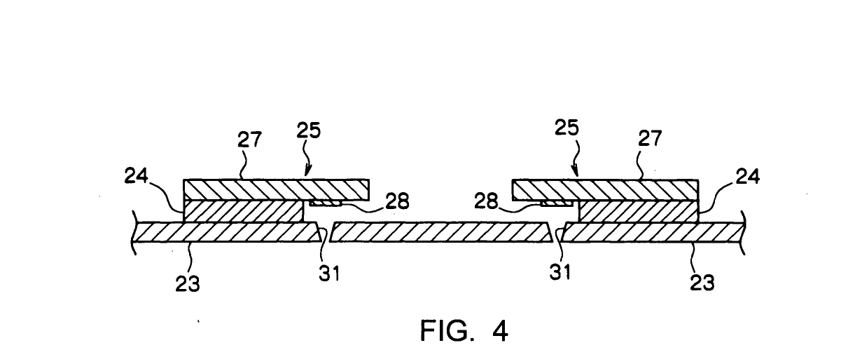

Therefore, the nozzle sheet is formed by an electroforming method using nickel or a material comprising nickel because this method makes it possible to form discharge nozzles of the same required shape and size precisely at the proper locations on the nozzle sheet at the same time, and has good reproducibility. In the embodiment, since the electroformed layer 105 is thinner than the resist layer 103, as shown in FIG. 4, the cross-sectional shape of each discharge nozzle 31 is smoothly narrower towards a growth surface. By affixing the head chips 25 to the growth surface side of the electroformed layer 105 by making use of such a shape, an ink discharge angle is stabilized, thereby increasing ink landing precision. In order to show the relationship between the position of the nozzle sheet 31 and the positions of the head chips 25 in a simple manner, the other structural components are not shown in FIG. 4.

Although, in the embodiment, nickel having excellent ink resistance is used as the material of the electroformed layer, that is, the nozzle sheet, copper may also be used as the material of the nozzle sheet.

Although the substrate 101 is made of stainless steel because stainless steel has excellent flattening characteristics and increases the separability of natural oxide film, it may also be made of glass sputtered with chromium.

The head chips 25 include the heaters 28 as energy generating elements for generating pressure energy for discharging ink from the discharge nozzles of the discharge nozzle rows for the respective colors formed in the nozzle sheet 23 formed by separating the electroformed layer 105 from the substrate 101 as described above. As shown in FIG. 3, with an ink discharging direction and the surfaces of the heaters (recording elements) 28 being perpendicular to each other, the head chips 25 are affixed to the nozzle sheet 23 in order perform a face-shooter method. In this embodiment, ink is discharged by the face-shooter method because the head chips 25 are stably affixed to the nozzle sheet.

As described above, the print head is formed by affixing the head chips 25 to one nozzle sheet 23 where the discharge nozzle rows for the respective colors are formed precisely at the proper positions. Therefore, even if any of the head chips 25 are displaced, it is possible to prevent displacement of the corresponding discharge nozzles.

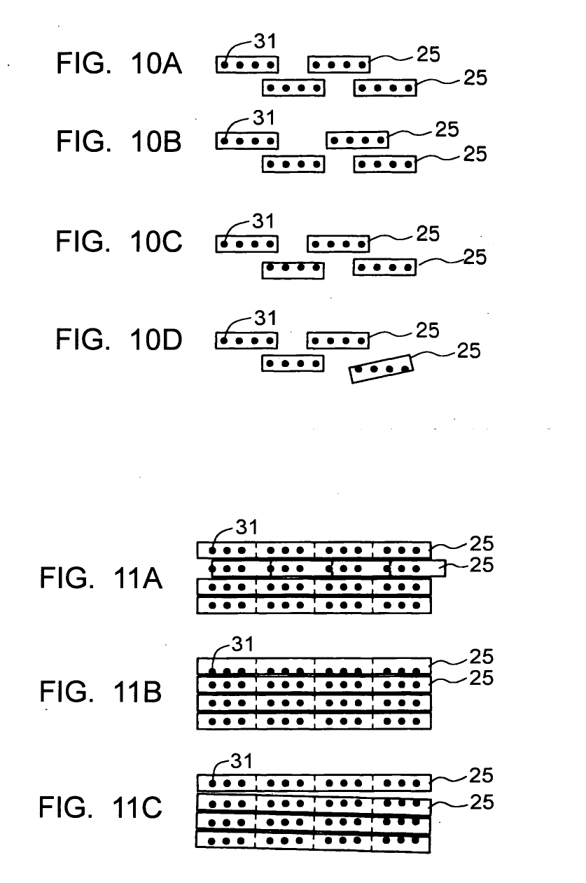

The reason is given with reference to FIGS. 11A to 11C.

FIG. 11A shows a case in which a head chip row 32 for a particular color is displaced in a head chip row direction; FIG. 11B shows a case in which a head chip row 32 is displaced in a sheet feed direction; and FIG. 11C shows a case in which head chip rows 32 for particular colors are tilted. Since the discharge nozzles are formed in the proper locations of the nozzle sheet with high precision, it is possible to prevent displacement between the discharge nozzles for the particular colors.

Accordingly, in this embodiment, it is possible to prevent a reduction in printing quality caused by the displacement of any of the discharge nozzles, and to stabilize the landing positions of the ink on the sheet. Therefore, the printing quality can be enhanced.

Although the embodiment is described using as an example a thermal line printer for discharging ink by driving heaters, the present invention is not limited thereto. Therefore, the present invention is applicable to, for example, a line printer for discharging ink by driving piezoelectric elements instead of heaters.

A line printer including the above-described print head 21 will be described with reference to FIG. 12.

A line printer 11 is in its entirety accommodated in a rectangular housing 12. By inserting a sheet tray 13 containing sheets 14 as recording medium into a slot in the front surface of the housing 12, the sheets 14 can be fed.

When the sheet tray 13 is inserted into the line printer 11 from the slot, the sheets 14 are pushed against a sheet-feed roller 16 by a predetermined mechanism. Rotation of the sheet-feed roller 16 causes the sheets 14 to be fed towards the back of the line printer 11 from the sheet tray 13 in the direction of arrow A. In the line printer 11, reverse rollers 17 are disposed at a side towards which the sheets are fed. By, for example, rotation of the reverse rollers 17, the direction in which the sheets 14 are fed is switched to a forward direction, as indicated by arrow B.

In the line printer 11, the sheets 14 whose feeding direction is switched to the direction of arrow B are transported by, for example, spur rollers 18 so that the sheets 14 pass over the sheet tray 13, and are discharged from a discharge slot disposed towards the front surface of the line printer 11 as indicated by arrow C. In the line printer 11, the head cartridge 20 is replaceably disposed as indicated by arrow D between the spur rollers 18 and the discharge slot.

In the head cartridge 20, the head 21 including line heads for yellow, magenta, cyan, and black is disposed at the bottom of a holder 22 having a predetermined shape, and the yellow, magenta, cyan, and black ink cartridges Y, M, C, and B are successively disposed in the holder 22. This allows the line printer 11 to print images by discharging respective color inks onto the sheets 14 from the respective line heads.

As described above, since a nozzle sheet for four colors, which is a characteristic of the present invention, is provided, the positional precision of each discharge nozzles is compensated, thereby facilitating replacement of the cartridge compared to that in the past.

(Second Embodiment)

In the first embodiment, four discharge nozzle rows for the respective ink colors are formed in the nozzle sheet 23 substantially in straight lines and in the direction in which they traverse a sheet (print width direction), and the head chips 25 are disposed on the nozzle sheet in rows in substantially straight lines in correspondence with the discharge nozzles. In this embodiment, discharge nozzle rows for respective colors are disposed in a nozzle sheet so that discharge nozzles in predetermined numbers are in staggered arrangements, and head chips 25 are disposed on the nozzle sheet in staggered arrangements in correspondence with the discharge nozzles. The other structural features are the same as those of the first embodiment, and, thus, will not be described below. In addition, the method for producing the nozzle sheet is the same, and, thus, will not be described below either.

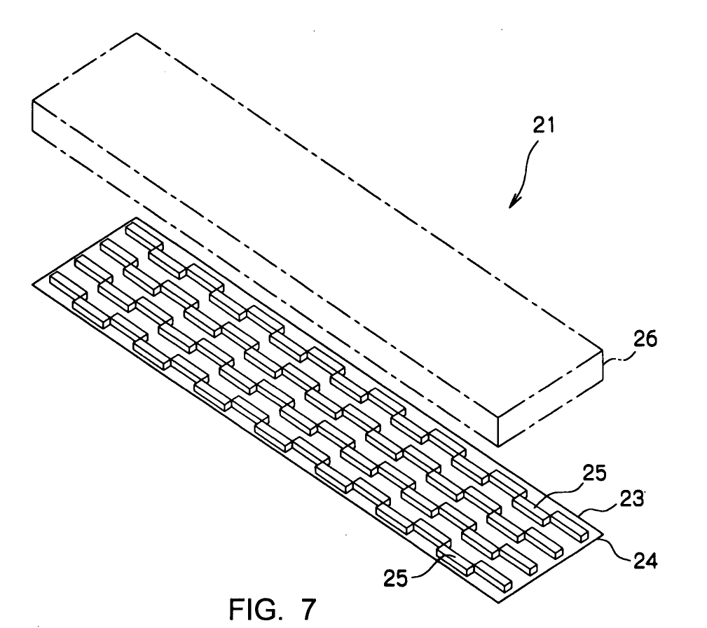

As shown in FIG. 7, a head 21 is formed of an electroformed layer formed of nickel or a material comprising nickel. The head 21 comprises a nozzle sheet 23, a plurality of head chips (substrate members) 25, and a member 26. In the nozzle sheet 23, four discharge nozzle rows for respective colors, yellow, magenta, cyan, and black, are disposed in correspondence with printing operations using the colors yellow, magenta, cyan, and black so that the discharge nozzles in predetermined numbers are disposed in staggered arrangements, with equal intervals between the discharge nozzles in a direction in which the rows traverse a sheet (that is, print width direction). In correspondence with the discharge nozzle rows for the respective colors, the head chips 25 are disposed on the nozzle sheet 23 in the staggered arrangements and are affixed to the nozzle sheet 23. A surface of the member 26 facing the head chips 25 is subsequently processed into a rough surface and is affixed to the nozzle sheet 23, so that ink paths are formed between the member 26 and the head cartridge 20 shown in FIG. 12.

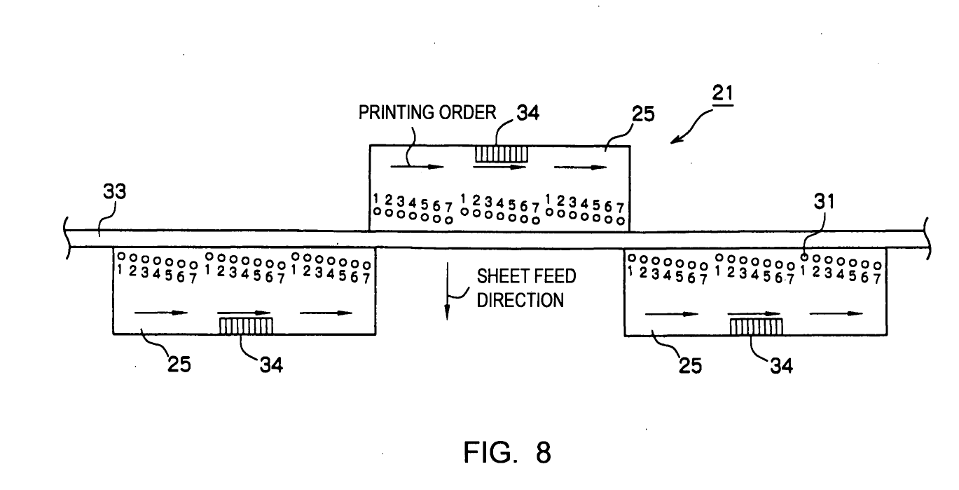

FIG. 8 shows the arrangement of the head chips 25 in the embodiment, and is an enlarged view of a portion from the side of the sheet 14 in FIG. 12. As shown in FIG. 8, the head chips 25 having the same structures are disposed on the nozzle sheet 23 in an alternately displaced manner (staggered arrangement) on both sides of ink paths 33 for the respective colors. In each head chip 25, heaters 28 are disposed at ink path sides, that is, the head chips 25 on both sides of the ink paths 33 are oriented so that each head chip 25 on one side is rotated 180 degrees with respect to each head chip 25 on the other side. This makes it possible for the head 21 to supply ink to each head chip 25 through one ink path 33 system for each color. Accordingly, the structure of the head 21 is simplified, so that the printing precision results in higher resolution.

Even if the head chips 25 are disposed by rotating each head chip 25 on one side through an angle of 180 degrees with respect to each head chip 25 on the other side, pads 34 are disposed at substantially the centers of sides of the respective head chips 25 in an arrangement direction of the discharge nozzles 31 (print width direction), so that the positions of the pads 34 are not changed. Thus, in the head 21, flexible wiring substrates connected to the pads 34 of adjacent head chips 25 are prevented from being disposed close to each other, that is, from being concentrated at one portion.

When the discharge nozzles are shifted in this manner, the order in which the heaters of the head chips above the ink paths 33 are driven by drive signals is opposite to the order in which the heaters of the head chips below the ink paths 33 are driven by drive signals. Therefore, in the embodiment, each head chip 25 is formed so that the driving order by a drive circuit can be switched.

Accordingly, in the embodiment, in the one nozzle sheet 23, four discharge nozzle rows for the respective ink colors are disposed precisely at the proper locations so that the discharge nozzles in predetermined numbers are in the staggered arrangements with the distance between the centers of adjacent discharge nozzles being equal in the direction in which the discharge nozzle rows traverse the sheet (print width direction). The head chips 25 are affixed to this one nozzle sheet 23 to form a print head. Therefore, as in the first embodiment, it is possible to prevent a reduction in printing quality caused by displacement of any of the discharge nozzles, and, thus, to stabilize the landing position of discharged ink on the sheet. In addition, the size of each discharge nozzle is reduced, and, thus, the interval between each nozzle is reduced. Therefore, it is possible to increase resolution.

(Third Embodiment)

In the second embodiment, four discharge nozzle rows for the respective colors are disposed in the nozzle sheet 23 so that discharge nozzles in predetermined numbers are in the staggered arrangements with the distance between each discharge nozzle being the same in the direction in which the discharge nozzle rows traverse the sheet (print width direction), and the head chips 25 are disposed on the nozzle sheet 23 in the staggered arrangements in correspondence with the discharge nozzle rows. In this embodiment, further, discharge nozzle rows are disposed so that each set of discharge nozzles partly overlaps another set of discharge nozzles in a sheet transportation direction (recording medium transportation direction).

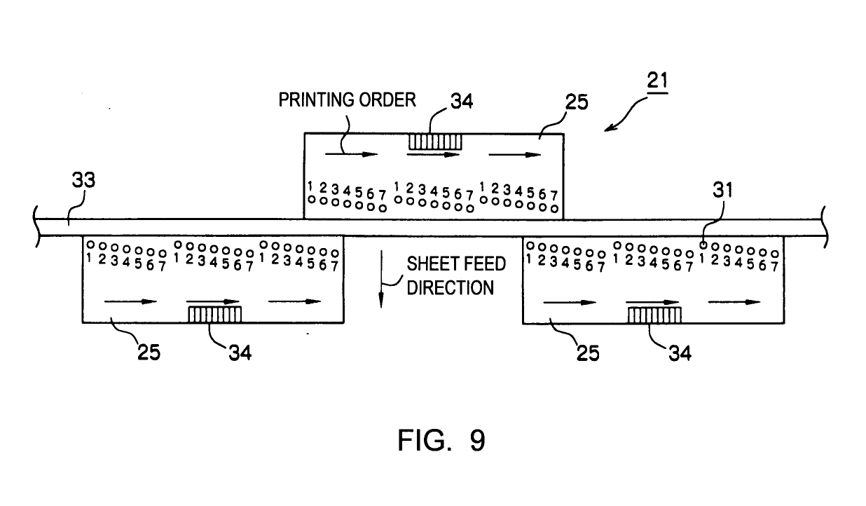

FIG. 9 shows the arrangement of head chips 25 in the embodiment, and is an enlarged view of a portion from the sheet 14 side in FIG. 12. As shown in FIG. 9, the discharge nozzles of the discharge nozzle rows for respective colors are disposed in staggered arrangements, and in such a manner that, of adjacent discharge nozzles in staggered arrangements, three discharge nozzles 31 and another three discharge nozzles 31 overlap in a sheet-feed direction.

By virtue of the above-described structure, overlapping portions where the locations for forming dots by the discharge nozzles are adjacent each other allow mixture of dots by the corresponding two adjacent head chips. The mixture of the dots makes the variations of the characteristics between the adjacent head chips less noticeable, and, thus, can prevent a reduction in printing quality.

FIG. 10A shows a case in which, for example, when a print head is formed by disposing the head chips 25 for the respective colors in the staggered arrangements in the sheet-feed direction, the discharge nozzles are disposed at equal intervals in the arrangement direction of the head chips 25, that is, the head chips are not displaced. FIG. 10B shows a case in which a head chip 25 is displaced in a direction in which the head is disposed, that is, in a direction perpendicular to the sheet-feed direction; FIG. 10C shows a case in which a head chip 25 is displaced in the sheet-feed direction; and FIG. 10D shows a case in which head chips 25 are tilted.

As can be seen from FIGS. 10B to 10D, even if any of the head chips 25 themselves are displaced, the discharge nozzles are formed in the nozzle sheet at the proper locations with high precision, so that it is possible to prevent displacement of any of the nozzles for each particular color.

Accordingly, in the embodiment, since the discharge nozzles are disposed in rows in the staggered arrangement so that each set of discharge nozzles partly overlaps another set of discharge nozzles in the sheet transportation direction (recording medium transportation direction), as in the second embodiment, it is possible to prevent a reduction in printing quality caused by displacement of any of the discharge nozzles, and, thus, to stabilize the landing position of discharged ink on the sheet. In addition, the size of each discharge nozzle is reduced, and, thus, the interval between each nozzle is reduced. Therefore, it is possible to increase resolution. Further, variations in the characteristics between adjacent head chips become less noticeable, and, thus, a reduction in printing quality is prevented.

Industrial Applicability

The inkjet print head, the inkjet printer, and the method for producing the inkjet print head are effective in preventing a reduction in printing quality caused by displacement of any of the discharge nozzles, and in stabilizing an ink discharge angle.

1. An inkjet print head having a plurality of recording elements disposed in a print width direction for discharging ink from discharge nozzles, the inkjet print head comprising:
one nozzle sheet comprising a predetermined electroformed metal layer and having the discharge nozzles disposed in rows for respective ink colors.

2. An inkjet print head according to claim 1, wherein the electroformed metal layer forming the nozzle sheet comprises nickel or a material comprising said nickel.

3. An inkjet print head having a plurality of recording elements disposed in a print width direction for discharging ink from discharge nozzles, the inkjet print head comprising:
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to the nozzle sheet so that the discharge nozzles in predetermined numbers in the discharge nozzle rows for the respective colors correspond to the recording elements.

4. An inkjet print head according to claim 3, wherein the electroformed metal layer forming the nozzle sheet comprises nickel or a material comprising said nickel.

5. An inkjet print head having a plurality of recording elements disposed in a print width direction for discharging ink from discharge nozzles, the inkjet print head comprising:
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to a growth surface of the nozzle sheet so that the discharge nozzles in predetermined numbers in the discharge nozzle rows for the respective colors correspond to the recording elements.

6. An inkjet print head according to claim 5, wherein the electroformed metal layer forming the nozzle sheet comprises nickel or a material comprising said nickel.

7. An inkjet print head having a plurality of recording elements disposed in a print width direction for discharging ink from discharge nozzles, the inkjet print head comprising:
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to the nozzle sheet so that the discharge nozzles in predetermined numbers in the discharge nozzle rows for the respective colors correspond to the recording elements, and
each discharge nozzle row for the corresponding color is disposed in a substantially straight line in the print width direction, and the substrate members are disposed in rows in straight lines in correspondence with the discharge nozzles.

8. An inkjet print head according to claim 7, wherein the electroformed metal layer forming the nozzle sheet comprises nickel or a material comprising said nickel.

9. An inkjet print head having a plurality of recording elements disposed in a print width direction for discharging ink from discharge nozzles, the inkjet print head comprising:
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to a growth surface of the nozzle sheet so that the discharge nozzles in predetermined numbers in the discharge nozzle rows for the respective colors correspond to the recording elements, and
each discharge nozzle row for the corresponding color is disposed in a substantially straight line, and the substrate members are disposed in rows in straight lines in correspondence with the discharge nozzles.

10. An inkjet print head according to claim 9, wherein the electroformed metal layer forming the nozzle sheet comprises nickel or a material comprising said nickel.

11. An inkjet print head having a plurality of recording elements disposed in a print width direction for discharging ink from discharge nozzles, the inkjet print head comprising:
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to the nozzle sheet so that the discharge nozzles in predetermined numbers in the discharge nozzle rows for the respective colors correspond to the recording elements, and
the discharge nozzle rows for the respective colors are disposed so that the discharge nozzles in predetermined numbers are in staggered arrangements, and the substrate members are in staggered arrangements in correspondence with the discharge nozzles.

12. An inkjet print head according to claim 11, wherein the electroformed metal layer forming the nozzle sheet comprises nickel or a material comprising said nickel.

13. An inkjet print head having a plurality of recording elements disposed in a print width direction for discharging ink from discharge nozzles, the inkjet print head comprising:
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to a growth surface of the nozzle sheet so that the discharge nozzles in predetermined numbers in the discharge nozzle rows for the respective colors correspond to the recording elements, and
the discharge nozzle rows for the respective colors are disposed so that the discharge nozzles in predetermined numbers are in staggered arrangements, and the substrate members are in staggered arrangements in correspondence with the discharge nozzles.

14. An inkjet print head according to claim 13, wherein the electroformed metal layer forming the nozzle sheet comprises nickel or a material comprising said nickel.

15. An inkjet print head having a plurality of recording elements disposed in a print width direction for discharging ink from discharge nozzles, the inkjet print head comprising:
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to the nozzle sheet so that the discharge nozzles in predetermined numbers in the discharge nozzle rows for the respective colors correspond to the recording elements, and
the discharge nozzle rows for the respective colors are disposed so that the discharge nozzles in predetermined numbers are in staggered arrangements and so that each set of the discharge nozzles partly overlaps another set of the discharge nozzles in a recording medium transportation direction, and the substrate members are in staggered arrangements in correspondence with the discharge nozzles.

16. An inkjet print head according to claim 11, wherein the electroformed metal layer forming the nozzle sheet comprises nickel or a material comprising said nickel.

17. An inkjet print head having a plurality of recording elements disposed in a print width direction for discharging ink from discharge nozzles, the inkjet print head comprising:
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to a growth surface of the nozzle sheet so that the discharge nozzles in predetermined numbers in the discharge nozzle rows for the respective colors correspond to the recording elements, and
the discharge nozzle rows for the respective colors are disposed so that the discharge nozzles in predetermined numbers are in staggered arrangements and so that each set of the discharge nozzles partly overlaps another set of the discharge nozzles in a recording medium transportation direction, and the substrate members are in staggered arrangements in correspondence with the discharge nozzles.

18. An inkjet print head according to claim 17, wherein the electroformed metal layer forming the nozzle sheet comprises nickel or a material comprising said nickel.

19. An inkjet printer comprising:
a replaceable head cartridge comprising an inkjet print head having a plurality of recording elements disposed in a print width direction for discharging ink from discharge nozzles, and
one nozzle sheet comprising a predetermined electroformed metal layer and having the discharge nozzles disposed in rows for respective ink colors.

20. An inkjet printer according to claim 19, wherein the electroformed metal layer forming the nozzle sheet comprises nickel or a material comprising said nickel.

21. An inkjet printer comprising:
a replaceable head cartridge comprising an inkjet print head having a plurality of recording elements disposed in a print width direction for discharging ink from discharge nozzles;
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to the nozzle sheet so that the discharge nozzles in predetermined numbers in the discharge nozzle rows for the respective colors correspond to the recording elements.

22. An inkjet printer according to claim 21, wherein the electroformed metal layer forming the nozzle sheet comprises nickel or a material comprising said nickel.

23. An inkjet printer comprising:
a replaceable head cartridge comprising an inkjet print head having a plurality of recording elements disposed in a print width direction for discharging ink from discharge nozzles;
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to a growth surface of the nozzle sheet so that the discharge nozzles in predetermined numbers in the discharge nozzle rows for the respective colors correspond to the recording elements.

24. An inkjet printer according to claim 23, wherein the electroformed metal layer forming the nozzle sheet comprises nickel or a material comprising said nickel.

25. An inkjet printer comprising:
a replaceable head cartridge comprising an inkjet print head having a plurality of recording elements disposed in a print width direction for discharging ink from discharge nozzles;
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to the nozzle sheet so that the discharge nozzles in predetermined numbers in the discharge nozzle rows for the respective colors correspond to the recording elements, and
each discharge nozzle row for the corresponding color is disposed in a substantially straight line, and the substrate members are disposed in rows in straight lines in correspondence with the discharge nozzles.

26. An inkjet printer according to claim 25, wherein the electroformed metal layer forming the nozzle sheet comprises nickel or a material comprising said nickel.

27. An inkjet printer comprising:
a replaceable head cartridge comprising an inkjet print head having a plurality of recording elements disposed in a print width direction for discharging ink from discharge nozzles;
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to a growth surface of the nozzle sheet of the nozzle sheet so that the discharge nozzles in predetermined numbers in the discharge nozzle rows for the respective colors correspond to the recording elements, and
each discharge nozzle row for the corresponding color is disposed in a substantially straight line, and the substrate members are disposed in rows in straight lines in correspondence with the discharge nozzles.

28. An inkjet printer according to claim 27, wherein the electroformed metal layer forming the nozzle sheet comprises nickel or a material comprising said nickel.

29. An inkjet printer comprising:
a replaceable head cartridge comprising an inkjet print head having a plurality of recording elements disposed in a print width direction for discharging ink from discharge nozzles;
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to the nozzle sheet so that the discharge nozzles in predetermined numbers in the discharge nozzle rows for the respective colors correspond to the recording elements, and
the discharge nozzle rows for the respective colors are disposed so that the discharge nozzles in predetermined numbers are in staggered arrangements with respect to a recording medium transportation direction, and the substrate members are in staggered arrangements in correspondence with the discharge nozzles.

30. An inkjet print head according to claim 29, wherein the electroformed metal layer forming the nozzle sheet comprises nickel or a material comprising said nickel.

31. An inkjet printer comprising:
a replaceable head cartridge comprising an inkjet print head having a plurality of recording elements disposed in a print width direction for discharging ink from discharge nozzles;
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to a growth surface of the nozzle sheet so that the discharge nozzles in predetermined numbers in the discharge nozzle rows for the respective colors correspond to the recording elements, and
the discharge nozzle rows for the respective colors are disposed so that the discharge nozzles in predetermined numbers are in staggered arrangements with respect to a recording medium transportation direction, and the substrate members are in staggered arrangements in correspondence with the discharge nozzles.

32. An inkjet printer according to claim 31, wherein the electroformed metal layer forming the nozzle sheet comprises nickel or a material comprising said nickel.

33. An inkjet printer comprising:
a replaceable head cartridge comprising an inkjet print head having a plurality of recording elements disposed in a print width direction for discharging ink from discharge nozzles;
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to the nozzle sheet so that the discharge nozzles in predetermined numbers in the discharge nozzle rows for the respective colors correspond to the recording elements, and
the discharge nozzle rows for the respective colors are disposed so that the discharge nozzles in predetermined numbers are in staggered arrangements and so that each set of the discharge nozzles partly overlaps another set of the discharge nozzles in a recording medium transportation direction, and the substrate members are in staggered arrangements in correspondence with the discharge nozzles.

34. An inkjet printer according to claim 33, wherein the electroformed metal layer forming the nozzle sheet comprises nickel or a material comprising said nickel.

35. An inkjet printer comprising:
a replaceable head cartridge comprising an inkjet print head having a plurality of recording elements disposed in a print width direction for discharging ink from discharge nozzles;
one nozzle sheet comprising a predetermined electroformed metal layer and having the discharge nozzles disposed in rows for respective ink colors; and
a plurality of substrate members, each including at least two of the plurality of recording elements, wherein
the substrate members are positioned at and affixed to a growth surface of the nozzle sheet so that the discharge nozzles in predetermined numbers in the discharge nozzle rows for the respective colors correspond to the recording elements, and
the discharge nozzle rows for the respective colors are disposed so that the discharge nozzles in predetermined numbers are in staggered arrangements and so that each set of the discharge nozzles partly overlaps another set of the discharge nozzles in a recording medium transportation direction, and the substrate members are in staggered arrangements in correspondence with the discharge nozzles.

36. An inkjet printer according to claim 35, wherein the electroformed metal layer forming the nozzle sheet comprises nickel or a material comprising said nickel.

37. A method for producing an inkjet print head having a plurality of recording elements disposed in a print width direction for discharging ink from discharge nozzles, the method comprising the steps of:
forming a resist layer having a predetermined pattern onto an electrically conductive substrate using an insulating photoresist material in correspondence with sizes of and distances between the discharge nozzles disposed in rows for respective ink colors;
selectively forming a layer on a portion of the substrate where the resist layer is not formed by electroforming using a predetermined metal;
removing the resist layer;
separating the electroformed layer from the substrate; and
positioning a substrate member comprising the plurality of recording elements at and affixing the substrate member to a nozzle sheet so that the discharge nozzles in predetermined numbers in the discharge nozzle rows for the respective colors correspond to the recording elements, the nozzle sheet being formed by separating the electroformed layer from the substrate.

38. A method for producing a print head according to claim 37, wherein the step of forming a layer by electroforming is carried out using a material comprising nickel.
